(19) United States
(12) Patent Application Publication
(10) Pub. No.: US 2010/0071731 A1
(43) Pub. Date: Mar. 25, 2010

(54) CLEANER

(76) Inventor: Ying-Chieh LIAO, Taichung City (TW)

Correspondence Address: Dr. BANGER SHIA;Int''l Patent Office of Bang Shia, 102 Lindencrest Ct, Sugar Land, TX, 77479-5201, US

(21) Appl. No.: 12/234,676

(22) Filed: Sep. 21, 2008

(51) Int. Cl. B08B 3/08

(52) U.S. Cl. 134/104.2

(57) ABSTRACT

A cleaner comprises a hollow housing being blow molded and made of plastic materials, and including a washing sink and an inner chamber, the washing sink being integrally formed on the upper end surface of the hollow housing and in the shape of a recessed cavity, and including an outlet arranged on the bottom surface thereof for communicating with the inner chamber in which the solvent is filled; and a power portion secured in the hollow housing and including a fluid absorbing end and an output hose, the fluid absorbing end being located in the inner chamber, one end of the output hose being in communication with the fluid absorbing end, and another end thereof communicating with the exterior, the power portion being used to supply power to make the fluid absorbing end absorb the solvent in the inner chamber and discharge the solvent out of the output hose.

### BACKGROUND OF THE INVENTION

1. Field of the Invention

The present invention relates to a cleaner, and more particularly to a cleaner that can wash a workpiece by way of the solvent.

2. Description of the Prior Art

In the vehicle maintenance workshops or factories, conventional cleaners are used to wash the vehicle parts with impurities. However, such conventional cleaners are too bulky to be moved easily. Moreover, the washing sink, the solvent receiving tank, and the inner pipe system are produced separately, having time consuming manufacture process.

The cleaner is made of steel materials or other metal materials, accordingly many seams will generate to leak the solvent outward.

The present invention has arisen to mitigate and/or obviate the afore-described disadvantages.

### SUMMARY OF THE INVENTION

The primary objective of the present invention is to provide a cleaner that is lightweight and moved easily.

A further objective of the present invention is to provide a cleaner that can be produced in less time and at lower cost.

Another objective of the present invention is to provide a cleaner that can obtain a seamless adjoining purpose to prevent the leak of the solvent.

To achieve the above-mentioned objectives, the cleaner provided in accordance with the present invention comprises:

a hollow housing being blow molded and made of plastic materials, and including a washing sink and an inner chamber, the washing sink being integrally formed on the upper end surface of the hollow housing, and including an outlet arranged on the bottom surface thereof for communicating with the inner chamber in which the solvent is filled; and a power portion secured in the hollow housing and including a fluid absorbing end and an output hose, the fluid absorbing end being located in the inner chamber, one end of the output hose being in communication with the fluid absorbing end, and another end thereof communicating with the exterior, the power portion being used to supply power to make the fluid absorbing end absorb the solvent in the inner chamber and discharge the solvent out of the output hose.

### BRIEF DESCRIPTION OF THE DRAWINGS

FIG. 1 is a perspective view illustrating the assembly of a cleaner according to the present invention;

FIG. 2 is a cross sectional view illustrating the assembly of the cleaner according to the present invention;

FIG. 3 is another cross sectional view illustrating the assembly of the cleaner according to the present invention;

FIG. 4 is another perspective view illustrating the assembly of the cleaner according to the present invention.

### DETAILED DESCRIPTION OF THE PREFERRED EMBODIMENT

The present invention will be clearer from the following description when viewed together with the accompanying drawings, which show, for purpose of illustrations only, the preferred embodiment in accordance with the present invention.

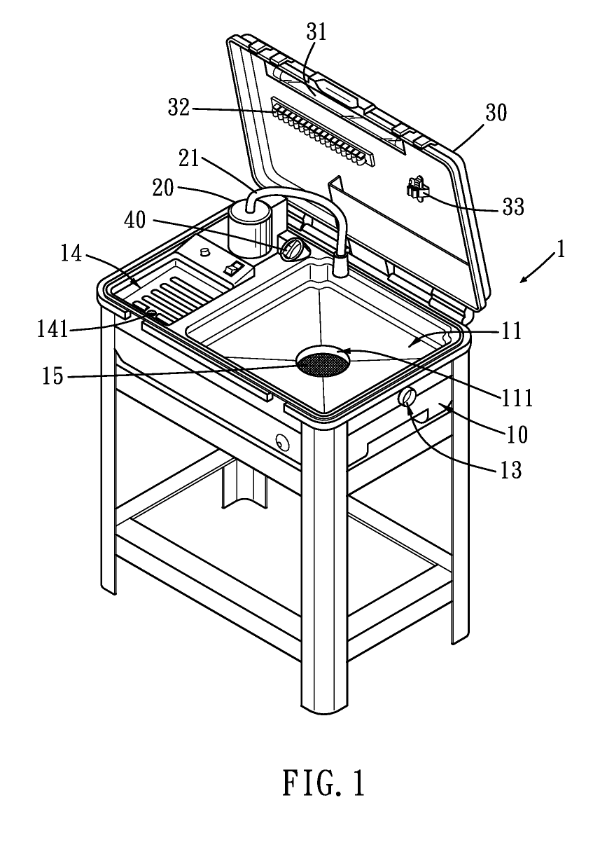

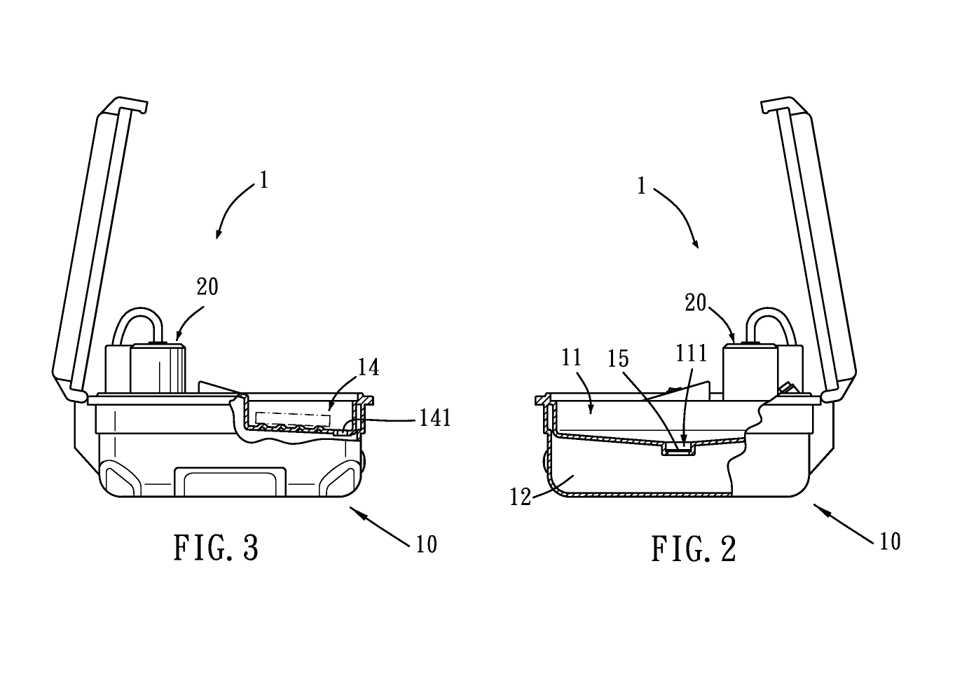

Referring to FIGS. 1 to 3, a cleaner 1 in accordance with the present invention comprises a hollow housing 10, a power portion 20, and an upper cover 30, wherein the hollow housing 10 is blow molded and made of plastic materials, and includes a washing sink 11, an inner chamber 12, an opening 13, and a dry tank 14. The washing sink 11 is integrally formed on the upper end surface of the hollow housing 10, and includes an outlet 111 in communication with the inner chamber 12 and the outer environment. The inner chamber 12 is used to fill the cleaning solvent therein. Furthermore, the opening 13 is in communication with the inner chamber 12 and the outer environment as well for filling and discharging the solvent. The dry tank 14 is also disposed on the upper end surface of the hollow housing 10 and includes a passage 141 formed on the bottom end thereof and communicating with the inner chamber 12. After washing the tools, they are placed into the dry tank 14 for being dried, and the solvent is recycled into the inner chamber 12 for being reused. Besides, in the outlet 111 is installed a filtering device 15 which can be a filter for filtering and cleaning the chipping or impurities attached on the tools. The hollow housing 10 further includes a temperature adjusting device 40 mounted thereon for adjusting the temperature of solvent based on the practical requirement.

The power portion 20 is secured in the hollow housing 10 and includes a fluid absorbing end (not shown) and an output hose 21, the fluid absorbing end is located in the inner chamber 12. One end of the output hose 21 is in communication with the fluid absorbing end, and another end thereof communicates with the exterior. The power portion 20 is used to supply power to make the fluid absorbing end absorb the solvent in the inner chamber 12 and discharge the solvent out of the output hose 21, thereby forming a circulating system to reuse the solvent to clean the tools.

One side of the upper cover 30 is axially connected with the hollow housing 10, and the power portion 20 allows to be removed from the hollow housing 10 so as to cover the upper cover 30 on the hollow housing 10. The upper cover 30 further includes a locking element for locking the upper cover 30 with the hollow housing 10 together such that the user can put away and move the cleaner 1 easily. The upper cover 30 includes a light source 31, a tool holder 32, and a clamping seat 33 which are all fixed on the inner side of the upper cover 30, wherein the light source 31 is used for illumination purpose, the tool holder 32 serves to place/hang the tools or parts thereon, and the clamping seat 33 is applied to clamp the output hose 21 so as to facilitate the tool washing process. It is to be noted that the upper cover 30 is made of plastic materials.

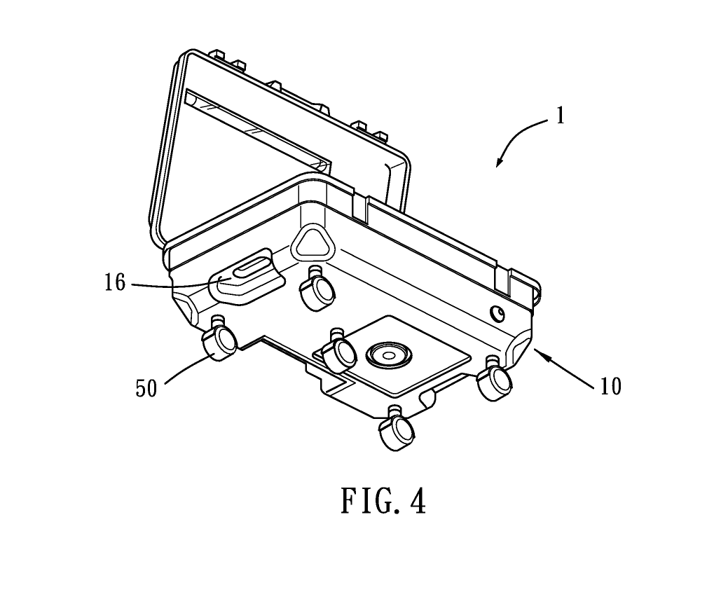

The cleaner not only can be held on a support rack but also includes a plurality of rolling wheels 50 installed on the bottom surface of the hollow housing 10 as shown in FIG. 4, so that the user can push the cleaner with mobility. On the two sides of the hollow housing 10 are individually arranged grip portions 16 or handles (not shown) such that the user can move the cleaner conveniently. On the bottom surface of the hollow housing 10 is mounted a discharging hole to discharge the solvent and eliminate the impurities in the inner chamber 12.

It can be clearly seen from the preceding accounts on the features of the present invention that the cleaner of the present invention has the following advantages:

1. Since the hollowing housing is blow molded and integrally made of plastic materials, the cleaner is lightweight and moved easily.

2. Most of the components of the cleaner are integrally fixed, thus simplifying manufacture process and lowering production cost.

3. The cleaner of the present invention can obtain a seamless adjoining purpose to prevent the leak of the solvent.

While we have shown and described various embodiments in accordance with the present invention, it is clear to those skilled in the art that further embodiments may be made without departing from the scope of the present invention.

What is claimed is:

1. A cleaner comprising:
a hollow housing being blow molded and made of plastic materials, and including a washing sink and an inner chamber, the washing sink being integrally formed on the upper end surface of the hollow housing and in the shape of a recessed cavity, and including an outlet arranged on the bottom surface thereof for communicating with the inner chamber in which the solvent is filled; and
a power portion secured in the hollow housing and including a fluid absorbing end and an output hose, the fluid absorbing end being located in the inner chamber, one end of the output hose being in communication with the fluid absorbing end, and another end thereof communicating with the exterior, the power portion being used to supply power to make the fluid absorbing end absorb the solvent in the inner chamber and discharge the solvent out of the output hose.

2. The cleaner as claimed in claim 1, wherein the hollow housing further includes an opening which is in communication with the inner chamber and the environment for filling and discharging the solvent.

3. The cleaner as claimed in claim 1 further comprising a filtering device which is installed in the outlet.

4. The cleaner as claimed in claim 1, wherein the hollow housing further includes a dry tank integrally formed on the upper end surface thereof, and the dry tank includes a passage formed on the bottom end thereof and communicating with the inner chamber.

5. The cleaner as claimed in claim 1, wherein on the bottom surface of the hollow housing are installed a plurality of rolling wheels.

6. The cleaner as claimed in claim 1 further comprising an upper cover which allows to be covered on the hollow housing.

7. The cleaner as claimed in claim 6, wherein on the inner side of the upper cover is fixed a clamping seat for clamping the output hose.

8. The cleaner as claimed in claim 1 further comprising a temperature adjusting device mounted on the hollow housing.
